(19) United States
(12) Patent Application Publication
(10) Pub. No.: US 2012/0140411 A1
(43) Pub. Date: Jun. 7, 2012

(54) HARD DISK DRIVE SIMULATING APPARATUS

(75) Inventors: ZHI-CHUN LIANG, Shenzhen City (CN); FANG TIAN, Shenzhen City (CN)

(73) Assignees: HON HAI PRECISION INDUSTRY CO., LTD., Tu-Cheng (TW); HONG FU JIN PRECISION INDUSTRY(Shenzhen) CO., LTD., Shenzhen City (CN)

(21) Appl. No.: 12/965,831

(22) Filed: Dec. 11, 2010

(30) Foreign Application Priority Data
Dec. 1, 2010 (CN) 201010566923.5

(51) Int. Cl. G06F 1/16

(52) U.S. Cl. 361/679.58

(57) ABSTRACT

A hard disk drive (HDD) simulating apparatus includes a main body and a connecting element. The main body has a substantially the same size as an HDD. The main body includes two fixing elements respectively arranged at two opposite sidewalls of the main body. The main body is operable to be fixed on an HDD bracket through the fixing elements. The connecting element is arranged on the main body. The connecting element includes a first HDD connector and a second HDD connector respectively exposed outside the main body. The first HDD connector is to be electrically connected to the second HDD connector. The second HDD connector is inserted in an HDD interface of a backboard using the HDD bracket.

### BACKGROUND

1. Technical Field

The present disclosure relates to a simulating apparatus for simulating a hard disk drive (HDD).

2. Description of Related Art

During designing or manufacturing servers, HDD interfaces of the servers may need to be tested. In one test method, a first terminal of an HDD cable is inserted in an HDD interface of a backboard of a server, and a second terminal of the HDD cable is inserted in an HDD interface of an external test device. However, the HDD interface of the backboard is arranged inside the server, which is inconvenient. Furthermore, the server may vibrate during testing and loosen the connection with the first terminal of the HDD cable.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a hard disk drive (HDD) simulating apparatus.

FIG. 2 is an assembled view of the HDD simulating apparatus of FIG. 1.

FIG. 3 is an isometric view of the HDD simulating apparatus of FIG. 1, in use to test an HDD interface of a backboard.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

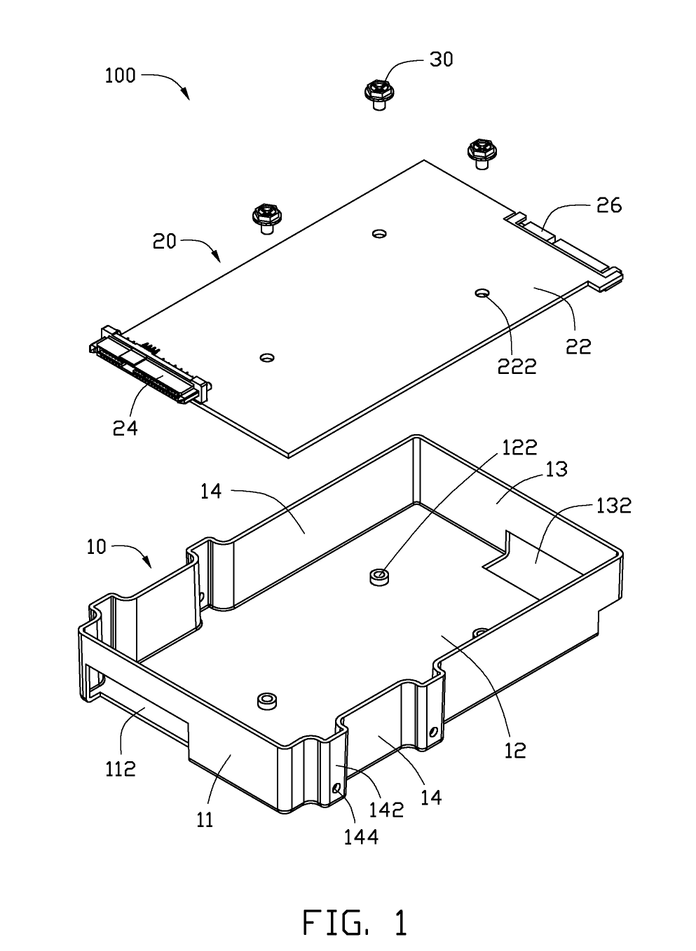

Referring to FIG. 1, an embodiment of a hard disk drive (HDD) simulating apparatus 100 includes a main body 10 and a connecting element 20.

The main body 10 is substantially rectangular and has a substantially same size as a common HDD. The main body 10 includes a bottom board 12, a front wall 11, a rear wall 13, and two sidewalls 14 perpendicularly extending up from four sides of the bottom board 12. A junction of the front wall 11 and the bottom board 12 defines a first opening 112. A junction of the rear wall 13 and the bottom board 12 defines a second opening 132. Two substantially rectangular ears 142 extend from each sidewall 14, and each ear 142 defines a screw hole 144. The bottom board 12 defines a plurality of screw holes 122, in this embodiment there are three screw holes.

The connecting element 20 includes a circuit board 22 having a substantially same size as the bottom board 12. The circuit board 22 defines a plurality of through holes 222 corresponding to the screw holes 122. The circuit board 22 includes a first HDD connector 24 and a second HDD connector 26 respectively arranged at opposite ends of the circuit board 22, and respectively corresponding to the first opening 112 and the second opening 132 of the main body 10. The first HDD connector 24 is electrically connected to the second HDD connector 26.

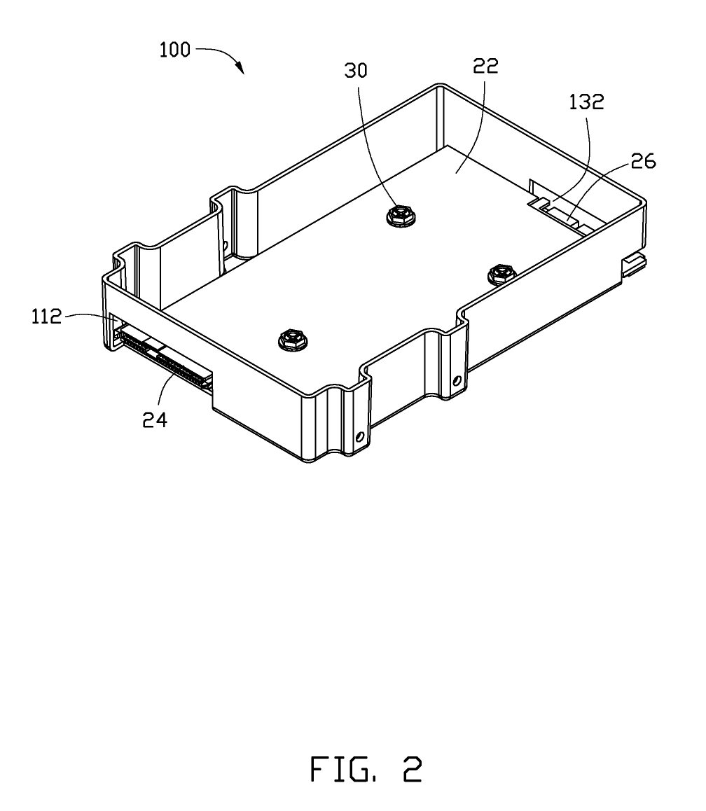

Referring to FIG. 2, in assembly, the connecting element 20 is received in the main body 10. The connecting element 20 is fixed in the main body 10 with screws 30 extending through the through holes 222 and screwed into the screw holes 122. At the same time, the first connector 24 and the second connector 26 are exposed from the main body 10 respectively through the first opening 112 and the second opening 132.

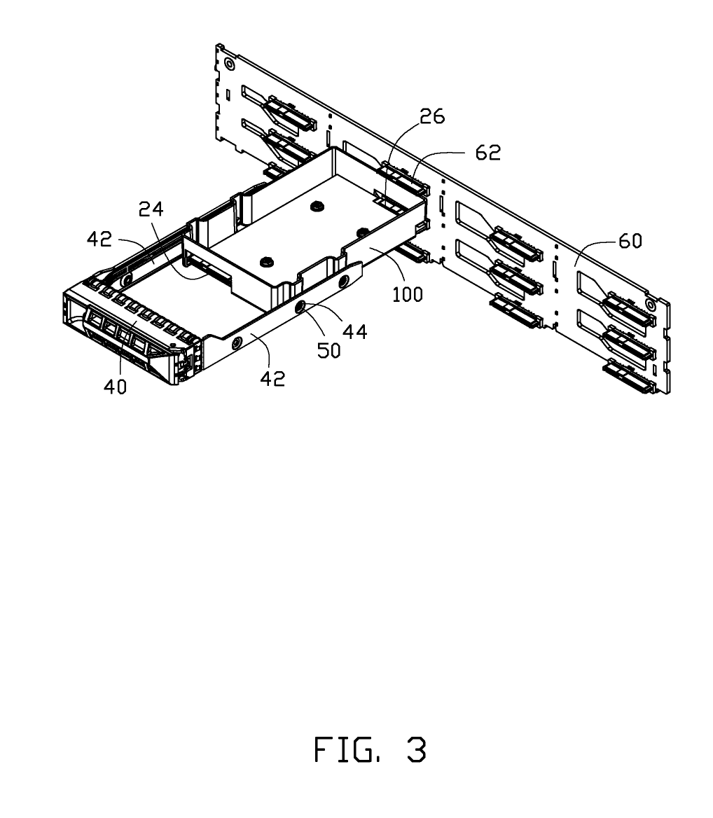

Referring to FIG. 3, when using the HDD simulating apparatus 100 to test an HDD interface 62 of a backboard 60 of a server (the other parts except the backboard 60 of the server are not shown), the HDD simulating apparatus 100 is fixed between two sides 42 of an HDD bracket 40 with screws 50 extending through the sides 42 and screwed into the screw holes 144 of the main body 10. The combined assembly of the HDD bracket 40 and the HDD simulating apparatus 100 is inserted into an enclosure (not shown) of the server, with the second HDD connector 26 inserted in the interface 62 of the backboard 60. The HDD bracket 40 and the installing relationship between the HDD bracket 40 and the enclosure of the server both fall within well-known technologies, and are therefore not described here in detail. The first HDD connector 24 is inserted in an HDD interface of an external test device (not shown) to complete the test. The HDD simulating apparatus 100 is fixed on the enclosure of the server with the HDD bracket 40, therefore preventing the second HDD connector 26 slipping or vibrating out of position.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A hard disk drive (HDD) simulating apparatus comprising:
a main body having a substantially same size as an HDD, the main body comprising two opposite sidewalls, and two fixing elements respectively arranged at the sidewalls of the main body, the main body operable to be fixed in an HDD bracket through the fixing elements; and
a connecting element arranged in the main body, the connecting element comprising a first HDD connector and a second HDD connector respectively exposed outside the main body, wherein the first HDD connector is to be electrically connected to the second HDD connector, and the second HDD connector is operable to be inserted in an HDD interface of a backboard.

2. The HDD simulating apparatus of claim 1, wherein the main body further comprises a bottom board, and a front wall and a rear wall substantially perpendicularly extending up from opposite ends of the bottom board, the sidewalls substantially perpendicularly extending up from opposite sides of the bottom board, the front wall defines a first opening to expose the first HDD connector, and the rear wall defines a second opening to expose the second HDD connector.

3. The HDD simulating apparatus of claim 2, wherein the fixing elements of the main board comprises two substantially rectangular ears extending from each sidewall, and each ear defines a screw hole for making the main body be fixed between two sides of the HDD bracket with screws extending through the two sides of the HDD bracket and screwed into the screw holes.

4. The HDD simulating apparatus of claim 1, wherein the connecting element further comprises a circuit board, the first and second HDD connectors are respectively arranged at two opposite ends of the circuit board.
